(19) United States
(12) Patent Application Publication
(10) Pub. No.: US 2005/0068228 A1
(43) Pub. Date: Mar. 31, 2005

(54) Systems and methods for implementing vector models for antenna communications

(76) Inventor: Jerry D. Burchfiel, Waltham, MA (US)

Correspondence Address: FISH & NEAVE IP GROUP;ROPES & GRAY LLP, ONE INTERNATIONAL PLACE, BOSTON, MA, 02110-2624, US

(21) Appl. No.: 10/671,023

(22) Filed: Sep. 25, 2003

(51) Int. Cl. H04B 1/44

(52) U.S. Cl. 342/357.06

(57) ABSTRACT

A reference vehicle (105-REF) includes a transceiver (205) and processing logic (230). The transceiver (205) couples to at least one antenna (210). The processing logic (230) determines a vector between the reference vehicle (105-REF) and a target vehicle (105-1) in a global coordinate system and translates the vector into a vehicle coordinate system that is referenced to the reference vehicle to produce a translated vector. The processing logic (230) further performs at least one of antenna selection, antenna steering and antenna gain calculation, based on the translated vector, to communicate with the target vehicle via the at least one antenna (210).

### FIELD OF THE INVENTION

The present invention relates generally to wireless networks and, more particularly, to systems and methods for implementing vector models for communicating via one or more antennas.

### BACKGROUND OF THE INVENTION

Many communications systems today operate in a three-dimensional environment in which the position and orientation of a communications target may be constantly changing with respect to a communications reference station. Such a system may include, for example, a mobile, multi-hop wireless network in which wireless nodes are added at locations in the system, and are removed from locations in the system in an ad-hoc fashion. In such an ad-hoc three-dimensional system, either an appropriate antenna and/or a transmit power necessary to transmit to the communications target may be constantly changing. If the reference station cannot keep track of the target relative to itself, it cannot ensure that an appropriate transmit power, given an antenna gain pattern, is used such that the target will receive the communication with an adequate signal strength. Additionally, if the reference station has more than one antenna, the reference station may have difficulty selecting an appropriate antenna for transmitting to, or receiving from, the target.

Therefore, there exists a need for systems and methods that can determine an appropriate antenna from multiple antennas, or an appropriate transmit power, for communicating between a communications target and a reference station in, for example, a three-dimensional operational environment.

### SUMMARY OF THE INVENTION

Systems and methods consistent with the present invention address this and other needs by implementing a vector model for communicating between a reference station and a target station in a wireless communications network. Systems and methods consistent with the invention may employ the vector model for translating a vector between the reference station and the target station in a global coordinate system to a local vehicle coordinate system that is referenced to the reference station. The translated vector may be used at the reference station for selecting, in the local vehicle coordinate system, between antennas for transmitting to, or receiving from, the target, or for determining an antenna gain, and a corresponding transmit power for transmitting to the target. The vector model, consistent with the invention, employs vector differences, dot products, cross products and vector normalizations that can execute far faster on limited computational resources than would be the case if angles and trigonometric functions were employed.

In accordance with the purpose of the invention as embodied and broadly described herein, a method of communicating with a target vehicle includes determining a vector (\vec{v}) between a reference vehicle and a target vehicle in a global coordinate system. The method further includes translating the vector (\vec{v}) into a vehicle coordinate system that is referenced to the reference vehicle to produce a translated vector (\vec{i}_{\vec{v}}_{_{local}}) and performing at least one of antenna selection, antenna steering and antenna gain calculation, based on the translated vector (\vec{i}_{\vec{v}}_{_{local}}), to communicate with the target vehicle via at least one antenna.

In a further implementation consistent with the present invention, a method of rotating a line of sight vector between a reference vehicle and a target vehicle from a first coordinate system to a second coordinate system includes determining a line of sight vector between the reference vehicle and the target vehicle in a first coordinate system and determining a local gravity vector at the reference vehicle. The method further includes determining a local magnetic field vector at the reference vehicle and rotating the line of sight vector into a second coordinate system using the determined local gravity vector and the local magnetic field vector.

In an additional implementation consistent with the present invention, a method of rotating a vector between a reference vehicle and a target vehicle from a global coordinate system to a vehicle coordinate system includes determining a first vector between the reference vehicle and the target vehicle in the global coordinate system and determining a second vector, in the vehicle coordinate system, that is parallel to gravity, where the vehicle coordinate system is referenced to the reference vehicle. The method further includes determining a third vector, in the vehicle coordinate system, that points to true north and using vector algebra and the second and third vectors to rotate the first vector from the global coordinate system to the vehicle coordinate system.

### BRIEF DESCRIPTION OF THE DRAWINGS

The accompanying drawings, which are incorporated in and constitute a part of this specification, illustrate exemplary embodiments of the invention and, together with the description, explain the invention. In the drawings,

FIG. 1 illustrates an exemplary network in which systems and methods, consistent with the present invention, may be implemented;

FIG. 2 illustrates exemplary components of a vehicle of the network of FIG. 1 consistent with the present invention;

FIG. 3A illustrates an exemplary vehicle vector database consistent with the present invention;

FIG. 3B illustrates an exemplary vehicle vector data table consistent with the present invention;

FIG. 4 illustrates an exemplary vehicle local coordinate system consistent with the present invention;

FIG. 5 illustrates an exemplary antenna gain pattern associated with a directional antenna consistent with the present invention; and

FIGS. 6-8 are flow charts that illustrate a vector translation process for communicating with a target vehicle consistent with the present invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims.

Systems and methods consistent with the present invention provide mechanisms for implementing a vector model that translates a line of sight vector between a reference communication station and a target communication station in a global coordinate system to a local vehicle coordinate system that is referenced to the reference communication station. The translated line of sight vector can be used by the reference communication station in selecting an appropriate antenna, and an appropriate transmit power, for communicating with the target communication station.

### Exemplary Network

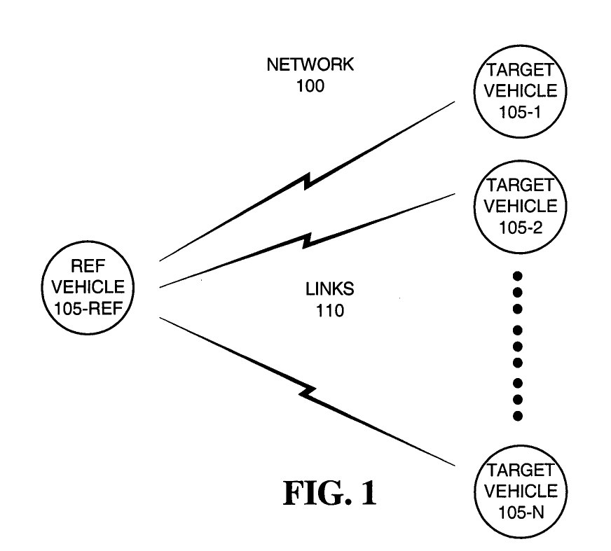

FIG. 1 illustrates an exemplary network 100 consistent with the present invention. In one implementation consistent with the present invention, network 100 may include a multi-hop, ad-hoc, wireless packet-switched network. In other implementations consistent with the invention, network 100 may include other types of networks, such as, for example, a circuit-switched network.

Network 100 may include multiple vehicles, such as reference vehicle 105 -REF and target vehicles 105-1 through 105-N (where N may include any integer greater than 1). Each “vehicle” may be a mobile entity, such as, for example, an automobile, an airplane, a helicopter, a missile or a satellite. Each “vehicle” may further include a stationary, or semi-stationary entity, such as, for example, a cellular base station or a stationary satellite.

Each vehicle 105 may have associated with it at least one antenna (not shown) used for communicating via one or more wireless links of links 110. The antenna associated with each vehicle 105 may include, for example, a single, or multiple, simple antennas; a single or multiple directional antennas; a phased array antenna; a switched antenna array; or any combination thereof.

The number of vehicles shown in FIG. 1 is for illustrative purposes only. Fewer or greater numbers of vehicles 105 may be employed in network 100 consistent with the present invention. In a multi-hop, ad-hoc, wireless packet-switched network, each vehicle 105 of network 100 may route packets on behalf of other vehicles and, thus, serve as an intermediate node between a packet source vehicle and destination vehicle in network 100.

### Exemplary Vehicle

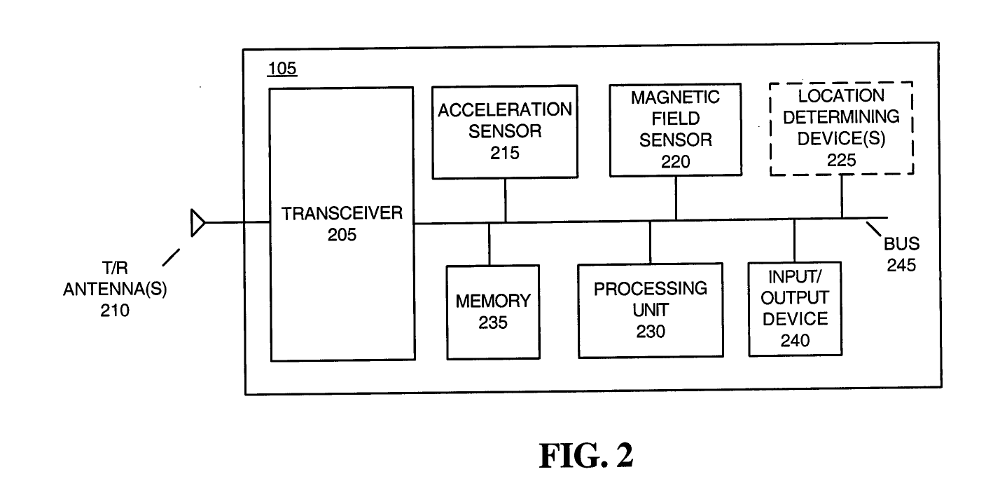

FIG. 2 illustrates exemplary components of a vehicle 105 of network 100, such as reference vehicle 105-REF or target vehicles 105-1 through 105-N. Vehicle 105 may include a transceiver 205, a transmit/receive (TIR) antenna(s) 210, an acceleration sensor 215, a magnetic field sensor 220, an optional vehicle location determining device(s) 225, a processing unit 230, a memory 235, input/output devices 240 and a bus 245.

Transceiver 205 may include transceiver circuitry well known to one skilled in the art for transmitting and/or receiving communications via T/R antenna(s) 210. For example, among other conventional circuitry, transceiver 205 may include an equalizer and an encoder/decoder. The equalizer may store and implement conventional Viterbi trellises for estimating received symbol sequences using, for example, a conventional maximum likelihood sequence estimation technique, and additionally include conventional mechanisms for performing channel estimation. The encoder/decoder may further include conventional circuitry for decoding and/or encoding received or transmitted symbol sequences.

Transmit/receive (T/R) antenna(s) 210 may include one or more simple omni-directional antennas, one or more directional antennas, a phased array antenna, or a switched antenna array. T/R antenna(s) 210 may include symmetric (i.e., similar gain patterns in the E and H planes) or non-symmetric antennas (i.e., significantly different gain patterns in the E and H planes).

Acceleration sensor 215 may include, for example, a three-axis “strap-down” accelerometer. In a steady state, the accelerometer may report the local components of the gravity vector \vec{g} as \vec{g}ₓ, \vec{g}_{y} and \vec{g}_{z} vectors. Magnetic field sensor 220 may include, for example, a three-axis “strap-down” magnetometer that reports the local components of the magnetic field \vec{m}ₓ as \vec{m}ₓ, \vec{m}_{y} and \vec{m}_{z} vectors.

Vehicle location determining device(s) 220 may include one or more devices that provide vehicle geographic location data. Device(s) 220 may include one or more of a Global Positioning System (GPS) device, an inertial management unit, or a vehicle navigation unit that provide a location of vehicle 105. If device(s) 220 includes a GPS device, then device 220 may supply geographic positions in global coordinates, such as standard world models like the World Geodetic System (WGS 84) or the Military Grid Reference System (MGRS). The World Geodetic System designates coordinates in latitude and longitude in degrees, and height over the geoid (mean sea level) in meters. The MGRS is based on the Universal Transverse Mercator (UTM) projection from 84 degrees north to 80 degrees south. In MGRS, the earth's surface is sliced into sixty North-South “orange slices,” with each slice being six degrees wide and projected onto a flat plane with coordinates Easting (distance in meters from the local meridian, which is centered every 6 degrees), Northing (distance in meters from the equator), and altitude (meters above sea level). MGRS has the advantage of providing genuine “local flat earth” three-vectors aligned with East (E), North (N) and up (U), suitable for local ballistics, intervisibility and other computations.

Processing unit 230 may perform all data processing functions for inputting, outputting, and processing of data including data buffering and vehicle control functions. Memory 235 provides permanent, semi-permanent, or temporary working storage of data and instructions for use by processing unit 230 in performing processing functions. Memory 235 may include large-capacity storage devices, such as a magnetic and/or optical recording medium and its corresponding drive. Input/Output device 240 may include conventional mechanisms for inputting and outputting data in video, audio, and/or hard copy format. Bus 245 interconnects the various components of vehicle 105 to permit the components to communicate with one another.

### Exemplary Vehicle Vector Database

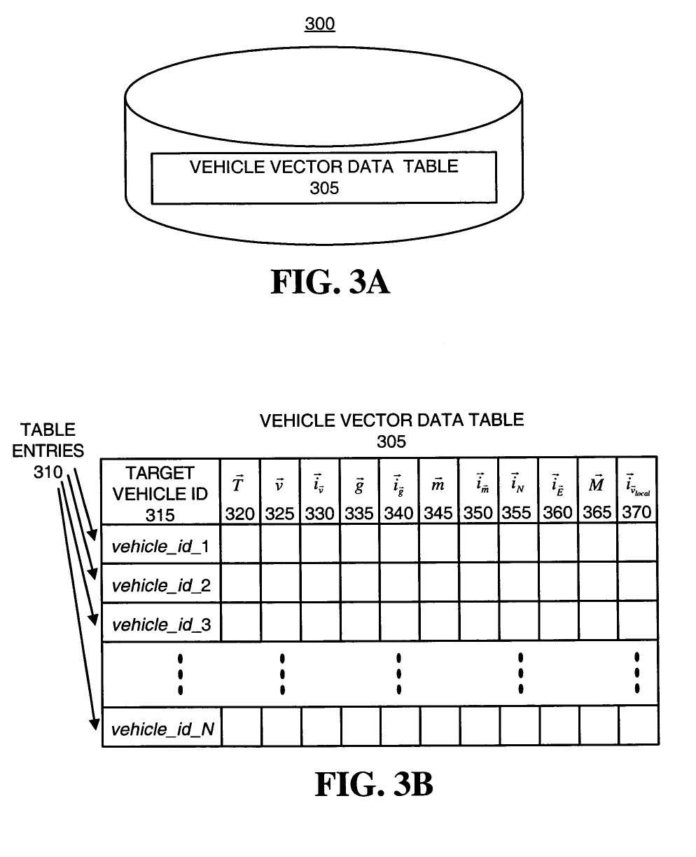

FIG. 3A illustrates an exemplary vehicle vector database 300 that stores vector data related to a location of reference vehicle 105-REF and one or more target vehicles 105-1 through 105-N. Database 300 may be stored in memory 235 of a vehicle 105, or stored external to vehicle 105. Database 800 may include one or more vehicle vector data tables 305, as further described below.

### Exemplary Vehicle Vector Data Table

FIG. 3B illustrates a vehicle vector data table 305 consistent with the present invention. Vehicle vector data table 305 may include multiple table entries 310, each of which may include a target vehicle identifier 315, and multiple vectors 320-370. Vector \vec{T} 320 may include a target vehicle's location vector in global coordinates. Vector \vec{v} 325 may include a line of sight vector from the reference vehicle to the target vehicle in global coordinates. Vector \vec{i}_{\vec{v}} 330 may include a normalized line of sight vector from the reference vehicle to the target vehicle in global coordinates. Vector \vec{g} 335 may include a vector that indicates the gravity acting upon a vehicle in the local vehicle's coordinate system. Vector \vec{i}_{\vec{g}} 340 may include a normalized vector that indicates the gravity acting upon a vehicle in the local vehicle's coordinate system. Vector \vec{m} 345 may include a vector that indicates the local components of the magnetic field in the local vehicle's coordinate system. Vector \vec{i}_{\vec{m}} 350 may include a normalized vector that indicates the local components of the magnetic field in the local vehicle's coordinate system. Vector \vec{i}_{N} 355 may include vector \vec{i}_{\vec{m}} 350 converted from magnetic to true north. Vector \vec{i}_{\vec{E}} 360 may include a unit vector in the east direction (i.e., the cross product of \vec{i}_{\vec{g}} and \vec{i}_{N}). Vector \vec{M} 365 may include a rotation vector that can rotate any vector in a global coordinate system into a vehicle's local coordinate system. Vector \vec{i}_{\vec{v}}_{_{local}} 370 may include vector \vec{i}_{\vec{v}} 330 rotated into a vehicle's local coordinate system using vector \vec{M} 365.

### Exemplary Vehicle Coordinate System

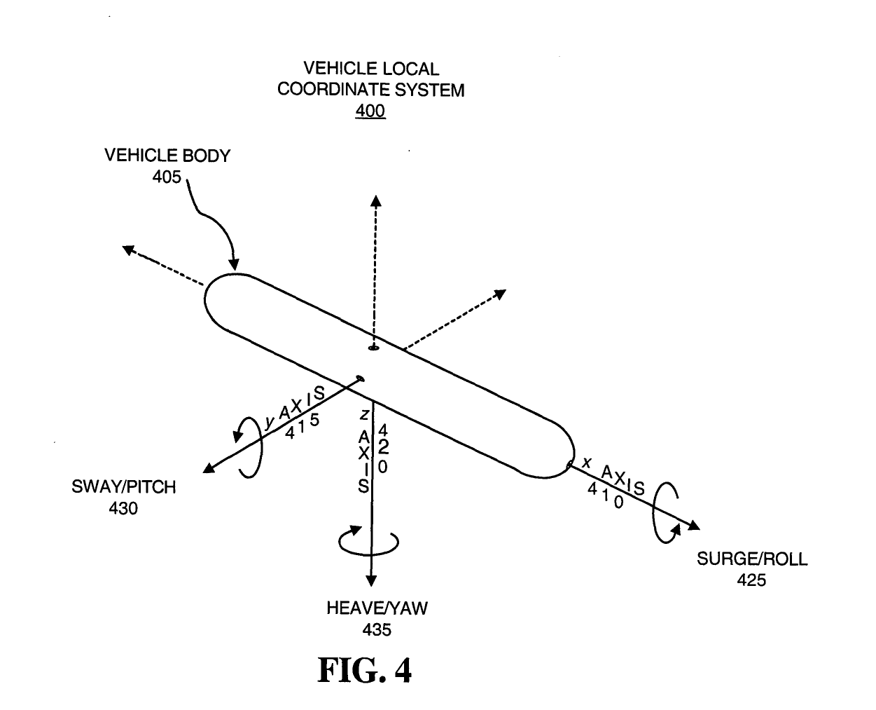

FIG. 4 illustrates an exemplary vehicle coordinate system consistent with the invention. As shown, a vehicle body 405 for each vehicle 105 has a local coordinate system in which the x axis 410 may be in the vehicle forward direction, the y axis 415 may be to the right of the vehicle forward direction, and the z axis 420 may be down. As with conventional aerospace standards, a number of motions may be associated with each axis. For example, surge/roll motions 425 may be associated with x axis 410, sway/pitch motions may be associated with y axis 415 and heave/yaw motions 435 may be associated with z axis 420. As shown in FIG. 4, the vehicle coordinate system includes a right-handed coordinate system, where rotations about the axes are also right handed. “Strap-down” sensors, such as, for example, the acceleration sensor 215 and magnetic field sensor 220 may measure components of external vectors (e.g., gravity, magnetic field) relative to the local vehicle coordinate system x 410, y 415 and z 420 axes.

### Exemplary Directional Antenna Gain Pattern

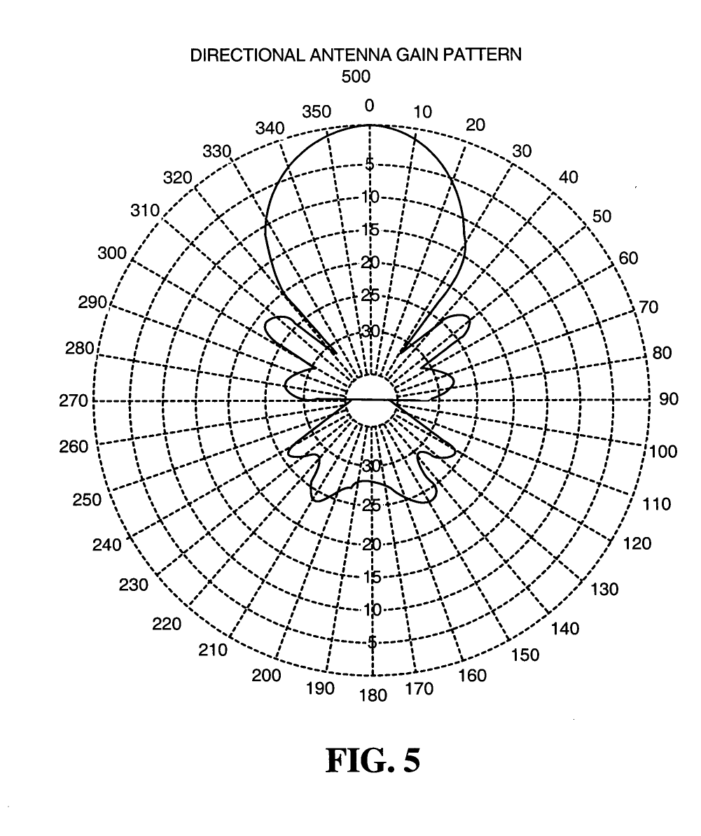

FIG. 5 illustrates an exemplary antenna gain pattern 500 consistent with the present invention. Antenna gain pattern 500 represents a graphical representation of the gain of a directional antenna at a particular elevation relative to a local vehicle coordinate system. Antenna gain pattern 500, thus, indicates a transmit and receive gain associated with a corresponding directional antenna at a full 360 degrees surrounding a directional antenna at a particular elevation. Though a gain pattern of a directional antenna is shown, one skilled in the art will recognize that different antenna gain patterns may be associated with different types of antennas. An omni-directional antenna, for example, may have a roughly circular gain pattern at a given elevation relative to a local vehicle's coordinate system.

### Exemplary Node Location Transmission Process

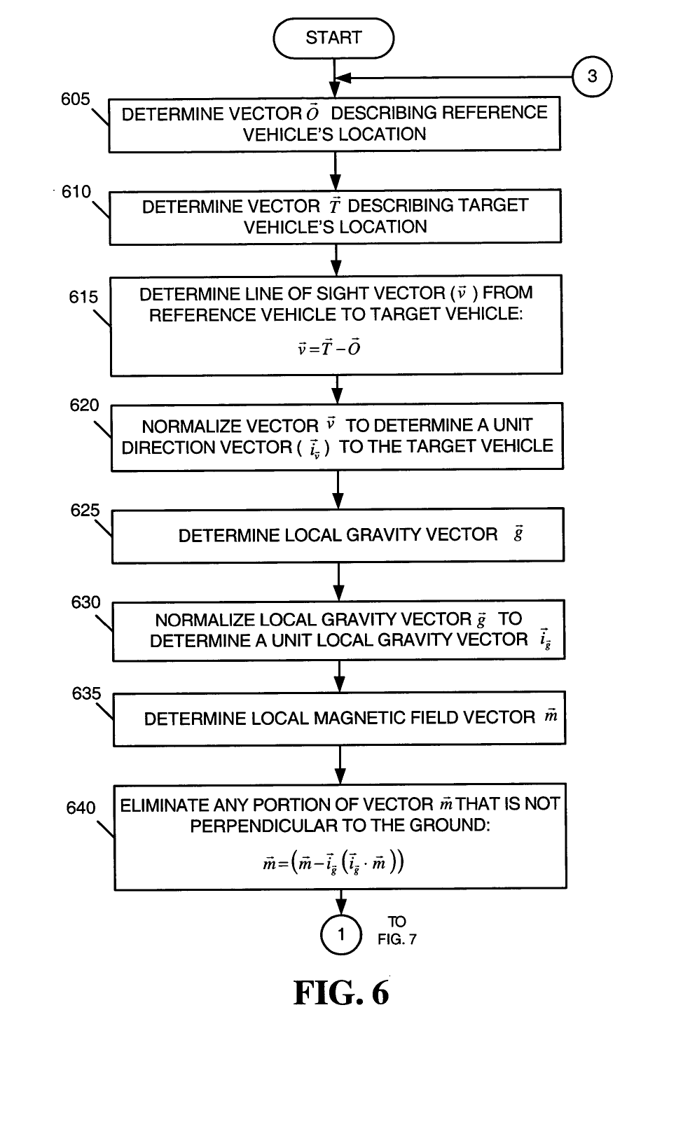

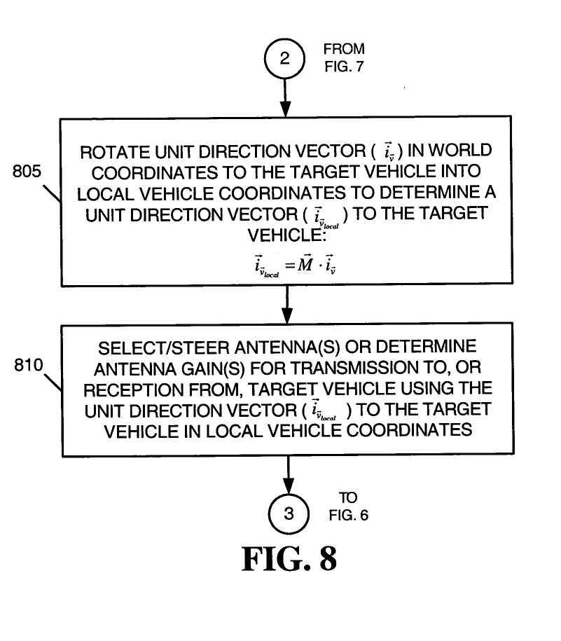

FIGS. 6-8 are flowcharts that illustrate an exemplary process, consistent with the present invention, for translating a vector to a target vehicle from a global coordinate system to a reference vehicle's local vehicle coordinate system. As one skilled in the art will appreciate, the process exemplified by FIGS. 6-8 can be implemented as a sequence of instructions and stored in memory 235 associated with reference vehicle 105-REF for execution by processing unit 230. Alternatively, the process exemplified by FIGS. 6-8 can be implemented in hardware and/or firmware.

The exemplary process may begin with a determination of a vector \vec{O} describing the reference vehicles 105-REF location [act 605](FIG. 6 ). Vector \vec{O} may be derived from data from location determining device 225, such as, for example, from GPS data in the WGS 84 or MGRS systems. A vector \vec{T} describing the target vehicle's 105 location may also be determined [act 610]. Vector \vec{T} may also be derived from data, such as, for example, from GPS data in the WGS 84 or MGRS systems, from a location determining device 225 associated with the target vehicle. Reference vehicle 105-REF may receive the target vehicle's location data in a message transmitted from the target vehicle or in a message from an external source (e.g., a vehicle location mapping station). A line of sight vector \vec{v} from the reference vehicle 105-REF to a target vehicle 105 may be determined [act 615] according to the following relation:
\vec{v}=\vec{T}−\vec{O} Eqn. (1)

Vector \vec{v} may then be normalized to determine a unit direction vector \vec{i}_{\vec{v}} to the target vehicle [act 620]. Vector \vec{v} may be normalized according to the following:

$${\vec{i}}_{\vec{v}} = \frac{\vec{v}}{\vert \vec{v} \vert} \qquad Eqn . ( 2 )$$

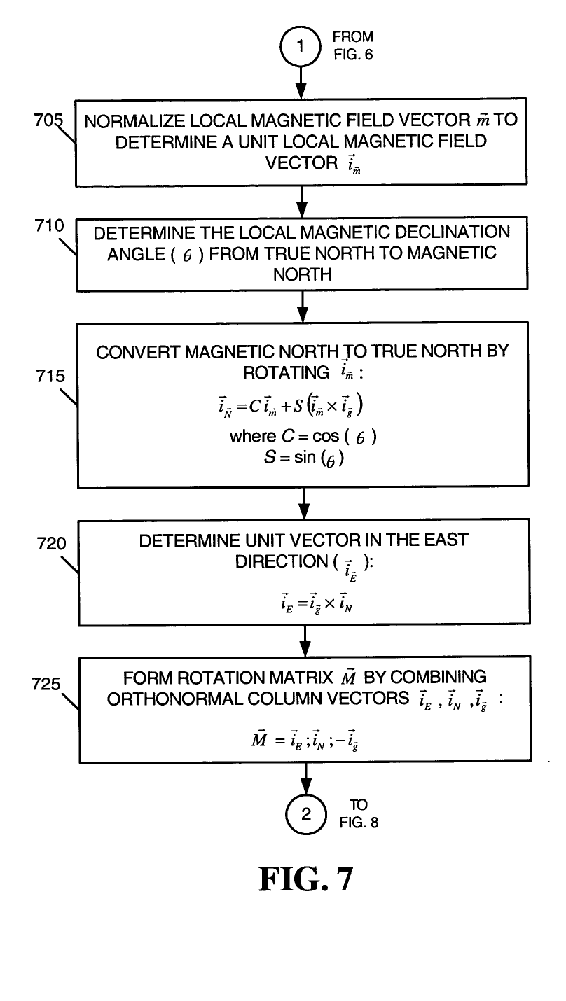

A local gravity vector g may be determined [act 625]. Local gravity vector g may be derived, for example, from data from acceleration sensor 215. Local gravity vector \vec{g} may then be normalized to determine a unit local gravity vector \vec{i}_{\vec{g}} [act 630]. A local magnetic field vector \vec{m} may then be determined [act 635]. Local magnetic field vector \vec{m} may, for example, be derived from data from magnetic field sensor 220. Since magnetic north is defined as parallel to the ground, any portion of the local magnetic field vector \vec{m} that is not perpendicular to the ground (i.e., perpendicular to gravity) may be eliminated according to the following:
\vec{m}=(\vec{m}−\vec{i}_{\vec{g}}(\vec{i}_{\vec{g}}·\vec{m})) Eqn. (3)
where the dot denotes a vector inner product. The resultant local magnetic field vector \vec{m} may then be normalized to determine a unit local magnetic field vector \vec{i}_{\vec{m}} [act 705](FIG. 7).

The local magnetic declination angle (θ) from true north to magnetic north may be determined [act 710], where θ is positive for E declination and negative for W declination. Unit vector \vec{i}_{\vec{m}} may be converted from magnetic north to true north [act 715] by rotating \vec{i}_{\vec{m}} in accordance with the following:
\vec{i}_{\vec{N}}=C\vec{i}_{\vec{m}}+S(\vec{i}_{\vec{m}}×\vec{i}_{\vec{g}}) Eqn. (4)
where C=cos(θ) and S=sin(θ). A unit vector in the east direction \vec{i}_{\vec{E}} may then be determined [act 720] according to the following relation:
\vec{i}_{E}=\vec{i}_{\vec{g}}×\vec{i}_{N} Eqn. (5)

A rotation matrix \vec{M} may then be formed [act 725] by combining orthonormal vectors \vec{i}_{E}, \vec{i}_{N}, \vec{i}_{\vec{g}} according to the following:
\vec{M}=\vec{i}_{E};\vec{i}_{N};−\vec{i}_{\vec{g}} Eqn. (6)

Unit direction vector \vec{i}_{\vec{v}} from the reference vehicle to the target vehicle, in global world coordinates, may then be rotated [act 805] into local vehicle coordinates to determine a unit direction vector \vec{i}_{\vec{v}}_{_{local}} to the target vehicle according to the following:
\vec{i}_{\vec{v}}_{_{local}}=\vec{M}·\vec{i}_{\vec{v}} Eqn. (7)

One or more antennas may then be selected or steered, or corresponding antenna gain(s) determined, for transmission to, or reception from, a target vehicle using the unit direction vector \vec{i}_{\vec{v}}_{_{local}} to the target vehicle in local vehicle coordinates [act 810]. The determined antenna gain(s) may further be used, for example, for determining an appropriate transmit power for transmitting to the target vehicle that ensures an adequate receive signal strength at the target vehicle.

In one implementation, for example, if there are a number of identical, simple “patch” antennas fixed to the reference vehicle 105-REF and pointing in different directions, the best antenna (i.e., highest gain) may be selected using the unit direction vector \vec{i}_{\vec{v}}_{_{local}}. Each antenna has a “boresight direction” of maximum gain given by a unit vector \vec{i}ₐ in local vehicle coordinates. Assuming that the antenna gain falls off smoothly (monotonically) as the direction to a target vehicle moves away from its boresight, the best (highest gain) antenna to use to reach a target vehicle in direction \vec{i}_{\vec{v}}_{_{local}} is to select the antenna that maximizes the following dot product:
\vec{i}ₐ·\vec{i}_{\vec{v}}_{_{local}} Eqn. (8)

The gain of an antenna may be determined (i.e., estimated) by a lookup of resulting dot product (Eqn. (8)) values in the range of 1 to 0, which correspond to the cosine of an angle zero to 90 degrees off boresight. Alternatively, the antenna gain can be approximated as a low-order polynomial function of the dot product.

A phased array antenna, for example, may be steered also using the unit direction vector \vec{i}_{\vec{v}}_{_{local}}. A phased array antenna is an array of elements that directs a beam by creating a phase gradient across its elements. Assume that an antenna has its own coordinate unit directions \vec{i}₁, \vec{i}₂ and \vec{i}₃, where \vec{i}₁ points along the antenna surface in one direction, \vec{i}₂ points along the antenna surface in an orthogonal direction, and \vec{i}₃ is equal to the cross product of \vec{i}₁ and \vec{i}₂ and is the unit vector normal to the antenna's surface. The antenna beam may be steered to the target vehicle by commanding it to present a phase gradient of 2π/λ \vec{i}ₜ·\vec{i}_{\vec{v}}_{_{local}} in the \vec{i}₁ direction and 2π/λ \vec{i}₂·\vec{i}_{\vec{v}}_{_{local}} in the \vec{i}₂ direction.

If an antenna is a non-symmetric antenna and has significantly different gain patterns in the E and H planes (assumed in its \vec{i}₁ and \vec{i}₂ directions), the antenna gain may additionally be determined using \vec{i}_{\vec{v}}_{_{local}}. The antenna gain may be expressed as the boresight gain (G) times an E plane off-axis factor ≦1, times an H plane off-axis factor ≦1. The E plane off-axis factor may be determined by doing a lookup or polynomial fit to the E plane pattern as a function of \vec{i}₁ and \vec{i}_{\vec{v}}_{_{local}}. The H plane off-axis factor may be determined by doing a lookup or polynomial fit to the H plane pattern as a function of \vec{i}₂ and \vec{i}_{\vec{v}}_{_{local}}. The resulting antenna gain may include G multiplied by the product of the two factors.

### Conclusion

Systems and methods consistent with the present invention, therefore, provide mechanisms for implementing a vector model for communicating between a reference station and a target station in a wireless communications network that translates a vector between the reference station and the target station in a global coordinate system to a local vehicle coordinate system that is referenced to the reference station. The translated vector may be used at the reference station for selecting, in the local vehicle coordinate system, between antennas for transmitting to, or receiving from, the target, or for determining an antenna gain, and a corresponding transmit power for transmitting to the target. The vector model, consistent with the invention, employs vector differences, dot products, cross products and vector normalizations that can execute far faster on limited computational resources than would be the case if angles and trigonometric functions were employed.

The foregoing description of embodiments of the present invention provides illustration and description, but is not intended to be exhaustive or to limit the invention to the precise form disclosed. Modifications and variations are possible in light of the above teachings or may be acquired from practice of the invention. For example, while series of acts have been described in FIGS. 6-8, the order of the acts may vary in other implementations consistent with the present invention. Also, non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the following claims and their equivalents.

1. A method of communicating with a target vehicle, comprising:
determining a vector (\vec{v}) between a reference vehicle and a target vehicle in a global coordinate system;
translating the vector (\vec{v}) into a vehicle coordinate system that is referenced to the reference vehicle to produce a translated vector (\vec{i}_{\vec{v}}_{_{local}}); and
performing at least one of antenna selection, antenna steering and antenna gain calculation, based on the translated vector (\vec{i}_{\vec{v}}_{_{local}}), to communicate with the target vehicle via at least one antenna.

2. The method of claim l,wherein the at least one antenna comprises a plurality of antennas and wherein performing antenna selection comprises:
selecting an antenna of the plurality of antennas that maximizes a dot product \vec{i}_{\vec{v}}_{_{local}}·\vec{i}ₐ for each antenna, wherein \vec{i}ₐ comprises a vector, in the vehicle coordinate system, that points in a direction of a maximum gain of a corresponding antenna of each of the plurality of antennas.

3. The method of claim 1, wherein performing antenna gain calculation comprises:
determining a dot product \vec{i}_{\vec{v}}_{_{local}}·\vec{i}ₐ and performing a lookup of resulting dot product values to determine a gain, wherein \vec{i}ₐ comprises a vector, in the vehicle coordinate system, that points in a direction of a maximum gain of the at least one antenna.

4. The method of claim 1, wherein performing antenna gain calculation comprises:
approximating antenna gain as a low-order polynomial function of a dot product \vec{i}_{\vec{v}}_{_{local}}·\vec{i}ₐ, wherein \vec{i}ₐ comprises a vector, in the vehicle coordinate system, that points in a direction of a maximum gain of the at least one antenna.

5. The method of claim 1, wherein the at least one antenna comprises a phased array antenna, wherein the phased array antenna has its own coordinate unit directions \vec{i}₁, \vec{i}₂ and \vec{i}₃, wherein \vec{i}₁ points along a surface of the phased array antenna in one direction, \vec{i}₂ points along the phased array antenna surface in an orthogonal direction, and \vec{i}₃ is equal to a cross product of \vec{i}₁ and \vec{i}₂ and is a unit vector normal to the phased array antenna's surface.

6. The method of claim 5, wherein performing antenna steering comprises:
commanding the at least one antenna to present a phase gradient of 2π/λ \vec{i}₁·\vec{i}_{\vec{v}}_{_{local}} in a direction corresponding to the \vec{i}₁ unit direction and 2π/λ \vec{i}₂·\vec{i}_{\vec{v}}_{_{local}} in a direction corresponding to the \vec{i}₂ unit direction.

7. The method of claim 1, wherein the global coordinate system comprises at least one of a World Geodetic System (WGS) and Military Grid Reference System (MGRS).

8. The method of claim 1, wherein translating the vector (\vec{v}) into a vehicle coordinate system comprises:
determining a unit gravity vector (\vec{i}_{\vec{g}}) in the vehicle coordinate system.

9. The method of claim 8, wherein translating the vector (\vec{v}) into a vehicle coordinate system comprises:
determining a unit magnetic field vector \vec{i}_{\vec{m}} in the vehicle coordinate system.

10. The method of claim 9, wherein translating the vector (\vec{v}) into a vehicle coordinate system comprises:
converting the unit magnetic field vector \vec{i}_{\vec{m}} to create a unit vector \vec{i}_{\vec{N}} that is referenced to true north.

11. The method of claim 10, wherein translating the vector (\vec{v}) into a vehicle coordinate system comprises:
determining a unit vector (\vec{i}_{\vec{g}}) in the east direction.

12. The method of claim 11, wherein translating the vector (\vec{v}) into a vehicle coordinate system comprises:
creating a translation matrix \vec{M} using \vec{i}_{\vec{g}}, \vec{i}_{\vec{N}} and \vec{i}_{\vec{E}}.

13. The method of claim 12, wherein translating the vector (\vec{v}) into a vehicle coordinate system comprises:
employing the matrix \vec{M} to translate the vector (\vec{v}) into the vehicle coordinate system to produce the translated vector \vec{i}_{\vec{v}}_{_{local}}.

14. A reference vehicle, comprising:
a transceiver coupled to at least one antenna; and
processing logic configured to:
determine a line of sight vector between the reference vehicle and a target vehicle in a global coordinate system, wherein the global coordinate system comprises at least one of a World Geodetic System (WGS) and Military Grid Reference System (MGRS),
translate the vector into a vehicle coordinate system that is referenced to the reference vehicle to produce a translated vector, and
perform at least one of antenna selection, antenna steering and antenna gain calculation, based on the translated vector, to communicate with the target vehicle via the at least one antenna.

15. A computer-readable medium containing instructions for controlling at least one processor to perform a method of communicating with a target vehicle, the method comprising:
determining a vector between a reference vehicle and a target vehicle in a global coordinate system;
translating the vector into a vehicle coordinate system that is referenced to the reference vehicle to produce a translated vector; and
performing at least one of antenna selection, antenna steering and antenna gain calculation, based on the translated vector, to communicate with the target vehicle via at least one antenna.

16. A method of rotating a line of sight vector between a reference vehicle and a target vehicle from a first coordinate system to a second coordinate system, comprising:
determining a line of sight vector between the reference vehicle and the target vehicle in a first coordinate system;
determining a local gravity vector at the reference vehicle;
determining a local magnetic field vector at the reference vehicle; and
rotating the line of sight vector into a second coordinate system using the determined local gravity vector and the local magnetic field vector.

17. The method of claim 16, wherein the second coordinate system comprises a vehicle coordinate system referenced to the reference vehicle.

18. The method of claim 16, wherein the first coordinate system comprises a global coordinate system.

19. The method of claim 18, wherein the global coordinate system comprises a Military Grid Reference System (MGRS).

20. The method of claim 16, wherein the local gravity vector is determined using an acceleration sensor.

21. The method of claim 20, wherein the acceleration sensor comprises a three-axis strap-down accelerometer.

22. The method of claim 16, wherein the local magnetic field vector is determined using a magnetic field sensor.

23. The method of claim 22, wherein the magnetic field sensor comprises a three-axis strap-down magnetometer.

24. The method of claim 16, wherein rotating the line of sight vector into a second coordinate system comprises:
creating a rotation matrix using the determined local gravity vector and the local magnetic field vector.

25. The method of claim 24, wherein rotating the line of sight vector into a second coordinate system further comprises:
rotating the line of sight vector using the rotation matrix.

26. A reference vehicle, comprising:
an acceleration sensor;
a magnetic sensor; and
processing logic configured to:
determine a line of sight vector between the reference vehicle and a target vehicle in a global coordinate system,
determine a local gravity vector at the reference vehicle using data from the acceleration sensor,
determine a local magnetic field vector at the reference vehicle using data from the magnetic sensor, and
rotate the light of sight vector into a vehicle coordinate system referenced to the reference vehicle using the determined local gravity vector and the local magnetic field vector.

27. A computer-readable medium containing instructions for controlling at least one processor to perform a method of rotating a line of sight vector between a reference vehicle and a target vehicle from a global coordinate system to a local vehicle coordinate system, the method comprising:
determining a line of sight vector between the reference vehicle and the target vehicle in a global coordinate system, wherein the global coordinate system comprises at least one of a World Geodetic System (WGS) and a Military Grid Reference System (MGRS);
determining a local gravity vector at the reference vehicle;
determining a local magnetic field vector at the reference vehicle; and
rotating the light of sight vector into a local vehicle coordinate system using the determined local gravity vector and the local magnetic field vector.

28. A method of rotating a vector between a reference vehicle and a target vehicle from a global coordinate system to a vehicle coordinate system, comprising:
determining a first vector between the reference vehicle and the target vehicle in the global coordinate system;
determining a second vector, in the vehicle coordinate system, that is parallel to gravity, wherein the vehicle coordinate system is referenced to the reference vehicle;
determining a third vector, in the vehicle coordinate system, that points to true north; and
rotating the first vector from the global coordinate system to the vehicle coordinate system using the second and third vectors.

29. The method of claim 28, wherein the global coordinate system comprises at least one of World Geodetic System (WGS) and Military Grid Reference System (MGRS).

30. The method of claim 28, wherein determining the second vector comprises:
using data, at the reference vehicle, from a three-axis strap-down accelerometer.

31. The method of claim 28, wherein determining the third vector comprises:
using data, at the reference vehicle, from a three-axis strap-down magnetometer.

32. The method of claim 28, wherein the vehicle coordinate system comprises a right-handed coordinate system with an x axis pointed in the vehicle forward direction, a y axis pointed to the right of the vehicle's forward direction, and a z axis pointed downward from the vehicle.

33. The method of claim 28, wherein the first vector comprises a line of sight vector between the reference vehicle and the target vehicle.

34. The method of claim 28, wherein the rotating further comprises:
using vector differences, dot products, cross products and vector normalizations to rotate the first vector from the global coordinate system to the vehicle coordinate system.

35. A first vehicle, comprising:
an acceleration sensor;
a magnetic sensor; and
processing logic configured to:
determine a first vector between the first vehicle and a second vehicle in a global coordinate system,
determine a second vector, in a vehicle coordinate system, that is parallel to gravity using data from the acceleration sensor, wherein the vehicle coordinate system is referenced to the first vehicle,
determine a third vector, in the vehicle coordinate system, that points to true north using data from the magnetic sensor, and
employ vector algebra and the second and third vectors to rotate the first vector from the global coordinate system to the vehicle coordinate system.

36. A computer-readable medium containing instructions for controlling at least one processor to perform a method of rotating a vector between a reference vehicle and a target vehicle from a global coordinate system to a vehicle coordinate system, the method comprising:
determining a first vector between the reference vehicle and the target vehicle in the global coordinate system;
determining a second vector, in the vehicle coordinate system, that is parallel to gravity, wherein the vehicle coordinate system is referenced to the reference vehicle;
determining a third vector, in the vehicle coordinate system, that points to true north; and
using vector algebra and the second and third vectors to rotate the first vector from the global coordinate system to the vehicle coordinate system.

37. A system for communicating with a target vehicle, comprising:
means for determining a vector between a reference vehicle and a target vehicle in a global coordinate system;
means for translating the vector into a vehicle coordinate system that is referenced to the reference vehicle to produce a translated vector; and
means for performing at least one of antenna selection, antenna steering and antenna gain calculation, based on the translated vector, to communicate with the target vehicle via at least one antenna.

38. A data structure encoded on a computer-readable medium, comprising:
first data indicating a line of sight vector between a reference vehicle and a target vehicle in a world coordinate system;
second data indicating a gravity vector corresponding to gravity experienced locally at the reference vehicle;
third data indicating a magnetic field vector in a vehicle coordinate system corresponding to a magnetic field experienced locally at the reference vehicle; and
fourth data indicating a rotation matrix constructed from at least the gravity vector and the magnetic field vector, wherein the rotation matrix rotates the line of sight vector from the world coordinate system to the vehicle coordinate system.

39. The data structure of claim 38, further comprising:
fifth data indicating a direction vector in a vehicle coordinate system corresponding to an eastward direction from the reference vehicle.

40. The data structure of claim 39, wherein the rotation matrix is constructed from at least the gravity vector, the magnetic field vector and the direction vector.
